(19) United States
(12) Patent Application Publication
(10) Pub. No.: US 2011/0160971 A1
(43) Pub. Date: Jun. 30, 2011

(54) Electro-Hydraulic Brake Brake-By-Wire System and Method

(76) Inventor: Dale Scott Crombez, Livonia, MI (US)

(21) Appl. No.: 12/702,378

(22) Filed: Feb. 9, 2010

(51) Int. Cl. G06F 19/00; B60T 13/74

(52) U.S. Cl. 701/70; 303/3

(57) ABSTRACT

An electro-hydraulic brake-by-wire system includes a brake pedal, an active vacuum booster coupled to the brake pedal, a master cylinder coupled to the active vacuum booster, at least one hydraulic brake circuit disposed in fluid communication with the master cylinder, at least one hydraulic front brake disposed in fluid communication with the at least one hydraulic brake circuit, an electronic control unit connected to the brake pedal and at least one electronic rear brake connected to the electronic control unit.

### CROSS-REFERENCE TO RELATED APPLICATIONS

This application is related to application attorney docket number 81199979 (67,600-124), filed Feb. 9, 2010 and entitled “Electronic Brake Actuator Brake-By-Wire System and Method”, and application attorney docket number 8199980 (67,600-123), filed Feb. 9, 2010 and entitled “Electro-Hydraulic Brake-By-Wire System and Method”.

### TECHNICAL FIELD

The disclosure generally relates to brake-by-wire systems for vehicles. More particularly, the disclosure relates to electro-hydraulic brake-by-wire systems having electronic rear brakes.

### BACKGROUND

Full hybrid vehicles may have brake-by-wire systems to facilitate coordinated or series regenerative braking. Brake-by-wire system architectures generally fall under one of 3 categories: electromechanical systems, which utilize electronic calipers; electro-hydraulic systems, which typically utilize a high-pressure accumulator with analog hydraulic valves to generate pressure that is applied to individual or multiple wheels; and vacuum-based systems, which utilize an active vacuum booster to generate hydraulic pressure that is applied to the wheel or wheels. These system architectures each have advantages and disadvantages in areas such as cost, packaging, durability and complexity. For example, the vacuum-based brake-by-wire system may be characterized by lower cost with some functional advantages but may lack other functionalities that the other systems provide. The vacuum-based brake-by-wire system typically requires an active booster in conjunction with a vacuum supply (electric vacuum pump) and a pedal-mounted brake feel simulator unit for all wheels of the vehicle. This arrangement may prevent independent front/rear braking pressure control and may have other disadvantages as well.

Therefore, electro-hydraulic brake-by-wire systems and methods are needed in which hydraulic rear brakes may be replaced with electronic rear brakes to provide cost, package and functional improvements.

### SUMMARY

The disclosure is generally directed to an electro-hydraulic brake-by-wire system. An illustrative embodiment of the system includes a brake pedal, an active vacuum booster coupled to the brake pedal, a master cylinder coupled to the active vacuum booster, at least one hydraulic brake circuit disposed in fluid communication with the master cylinder, at least one hydraulic front brake disposed in fluid communication with the at least one hydraulic brake circuit, an electronic control unit connected to the brake pedal and at least one electronic rear brake connected to the electronic control unit.

The disclosure is further generally directed to a vehicle which includes electro-hydraulic brake-by-wire system. An illustrative embodiment of the vehicle includes a chassis; a front axle and a rear axle carried by the chassis; a front pair of wheels and a rear pair of wheels carried by the front axle and the rear axle, respectively; a drive mechanism drivingly engaging at least one of the front axle and the rear axle; and an electro-hydraulic brake-by-wire system comprising a brake pedal; an active vacuum booster coupled to the brake pedal; a master cylinder coupled to the booster; at least one hydraulic brake circuit disposed in fluid communication with the master cylinder; at least one hydraulic front brake disposed in fluid communication with the at least one hydraulic brake circuit and adapted to engage at least one of the front pair of wheels; an electronic control unit connected to the brake pedal; and at least one electronic rear brake connected to the electronic control unit and adapted to engage at least one of the rear pair of wheels.

The disclosure is further generally directed to electro-hydraulic brake-by-wire method. An illustrative embodiment of the method includes providing a vehicle having a pair of front brakes and a pair of electronic rear brakes, providing an active vacuum booster, coupling a brake pedal to the active vacuum booster, coupling at least one hydraulic circuit to the active vacuum booster, connecting at least one of the pair of front brakes to the at least one hydraulic circuit, providing an electronic control unit, connecting the electronic control unit to the brake pedal and connecting at least one of the pair of electronic rear brakes to the electronic control unit.

### BRIEF DESCRIPTION OF THE DRAWINGS

The disclosure will now be made, by way of example, with reference to the accompanying drawings, in which:

FIG. 1 is a schematic diagram of an illustrative embodiment of the electro-hydraulic brake-by-wire system.

FIG. 2 is a schematic diagram of a vehicle fitted with an illustrative embodiment of the electro-hydraulic brake-by-wire system.

FIG. 3 is a flow diagram of an illustrative embodiment of an electro-hydraulic brake-by-wire method.

FIG. 4 is a schematic diagram of an alternative illustrative embodiment of the electro-hydraulic brake-by-wire system.

FIG. 5 is a schematic diagram of a vehicle fitted with the alternative illustrative embodiment of the electro-hydraulic brake-by-wire system shown in FIG. 4.

FIG. 6 is a flow diagram of an alternative illustrative embodiment of an electro-hydraulic brake-by-wire method.

FIG. 7 is a flow diagram of an illustrative embodiment of a method of operating an electro-hydraulic brake-by-wire system.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the claims. Furthermore, there is no intention to be bound by any expressed or implied theory presented in the preceding technical field, background, brief summary or the following detailed description.

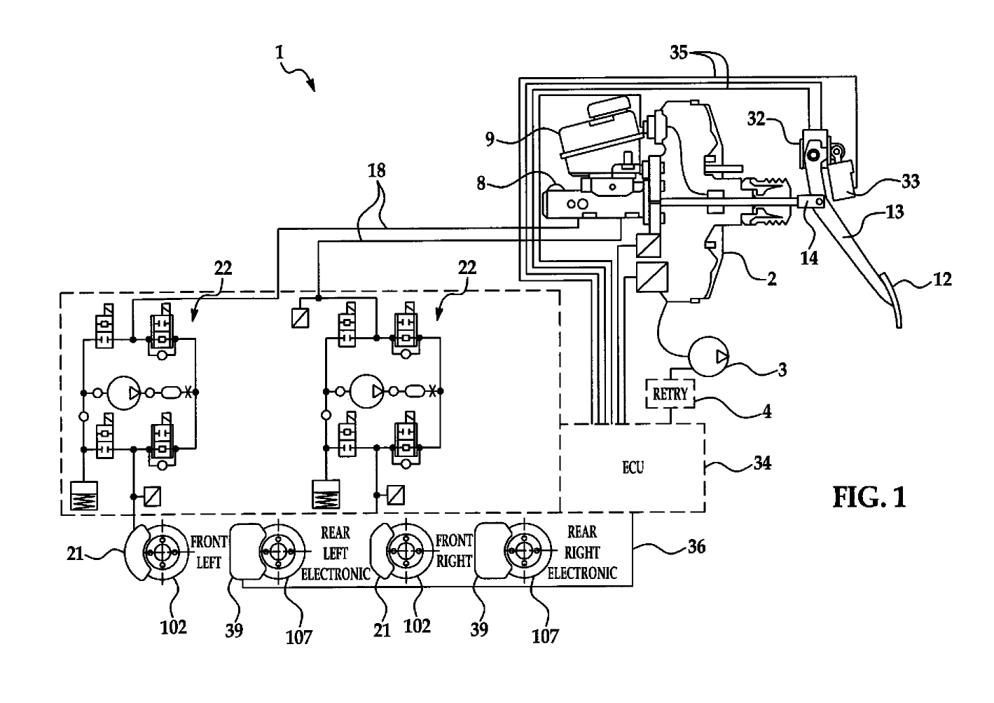

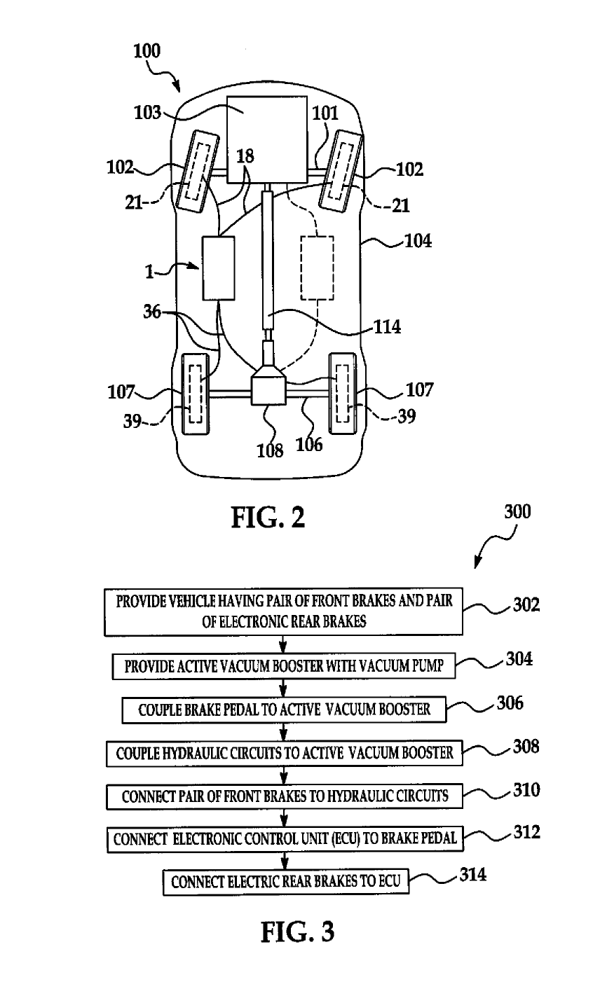

Referring initially to FIGS. 1 and 2, an illustrative embodiment of the electro-hydraulic brake-by-wire system, hereinafter system, is generally indicated by reference numeral 1. As shown in FIG. 2, the system 1 may be suitable for implementation in conjunction with an electric vehicle 100 such as a plug-in hybrid electric vehicle (HEV), for example and without limitation. Generally, the electric vehicle 100 may include a vehicle chassis 104 having a front axle 101 and a rear axle 106. The front axle 101 may be fitted with a pair of front wheels 102. The rear axle 106 may be fitted with a pair of rear wheels 107.

An internal combustion engine 103 may drivingly engage at least one of the front axle 101 and the rear axle 106. An electric motor 108 may additionally or alternatively drivingly engage at least one of the front axle 101 and the rear axle 106. A rechargeable battery (not shown) may be connected to the electric motor 108. The rechargeable battery may be capable of being recharged with electrical power at a charging destination (not shown) via suitable plug-in electrical equipment, as is known to those skilled in the art. The electric vehicle 100 may be adapted for propulsion by the front wheels 102 via the front axle 101 and/or by the rear wheels 107 via the rear axle 106 through engagement of the internal combustion engine 103. The electric vehicle 100 may additionally or alternatively be adapted for propulsion by the front wheels 102 via the front axle 101 and/or by the rear wheels 107 via the rear axle 106 through engagement of the electric motor 108. As will be hereinafter further described, the system 1 may be operable to apply hydraulically-actuated brake pressure to the front wheels 102 and electronically-actuated brake pressure to the rear wheels 107 of the vehicle 100.

As shown in FIG. 1, the system 1 may include an active vacuum booster 2, which may be conventional. A vacuum pump 3 may be disposed in fluid communication with the active vacuum booster 2. A master cylinder 8 may be coupled to the active vacuum booster 2. A hydraulic fluid reservoir 9 which contains a supply of hydraulic fluid (not shown) may be disposed in fluid communication with the master cylinder 8. A brake pedal 12 of the vehicle 100 may be provided on an elongated pedal arm 13 which is coupled to the active vacuum booster 2 through a pedal/booster coupling 14.

A pair of front hydraulic brake circuits 22 may be disposed in fluid communication with the master cylinder through respective hydraulic lines 18. The front hydraulic brake circuits 22 may be operably connected to a pair of hydraulic front brakes 21, respectively, which may be adapted to apply hydraulically-actuated brake pressure to the respective front vehicle wheels 102 of the vehicle 100 (FIG. 2), as will be hereinafter further described.

A pedal travel sensor 32 may be coupled to the pedal arm 13. An electronic control unit (ECU) 34 may be connected to the pedal travel sensor 32 through ECU wiring 35. The ECU 34 may additionally be connected to the valves, pumps and other various control components (not labeled) of each of the front hydraulic brake circuits 22. A pedal feel simulator 33 may additionally be provided on the pedal arm 13 and connected to the ECU 34 through ECU wiring 35. The vacuum pump 3 may be connected to the ECU 34 through a relay 4.

A pair of electronic rear brakes 39 may be connected to the ECU 34 through brake wiring 36. The electronic rear brakes 39 may be adapted to apply hydraulically-actuated brake pressure to the respective rear vehicle wheels 107 of the vehicle 100 (FIG. 2), as will be hereinafter further described.

In operation of the vehicle 100, the internal combustion engine 103 and/or the electric motor 108 applies torque to the front wheels 102 through the front axle 101 and/or to the rear wheels 107 through the rear axle 106 to propel the vehicle 100 on a surface (not shown). Braking is applied to the vehicle 100 as a vehicle operator (not shown) applies pressure to the brake pedal 12. Accordingly, the pedal arm 13 actuates the active vacuum booster 2 of the system 1 through the pedal/booster coupling 14. In turn, the active vacuum booster 2 pressurizes hydraulic fluid (not shown) in the master cylinder 8 and facilitates flow of the hydraulic fluid from the master cylinder 8 and through the hydraulic lines 18 and the respective front hydraulic brake circuits 22.

The hydraulic fluid which flows through the front hydraulic brake circuits 22 causes the hydraulic front brakes 21 to apply brake pressure against the respective front wheels 102 of the vehicle 100. The ECU 34 may control the valves, pumps and other components (not indicated) of each of the front hydraulic brake circuits 22 to facilitate flow of hydraulic fluid through the front hydraulic brake circuits 22 to each hydraulic front brake 21. As the brake pedal 12 is depressed, the pedal arm 13 also actuates the pedal travel sensor 32, which transmits an activation signal (not shown) to the ECU 34 through the ECU wiring 35. The ECU 34 transmits a braking signal (not shown) through the brake wiring 36 to each electronic rear brake 39, which applies brake pressure to each corresponding rear wheel 107. The resulting brake pressure which is applied to the front wheels 102 and the rear wheels 107 slows or stops the vehicle 100. As the brake pedal 12 is depressed during braking, the pedal feel simulator 33 may simulate mechanical resistance of the brake pedal 12 in proportion to the magnitude of braking which is applied.

It will be appreciated by those skilled in the art that the integrated rear electric brakes 39 of the system 1 offers numerous benefits including cost, package and function improvements over conventional brake arrangements, particularly with the increased use of electric park brakes. The system 1 may utilize common ABS/ESC controls which are common to conventional vacuum brake systems. The hydraulic front brakes 21 may allow for enhanced system sizing of the master cylinder 8 and pedal ratio of the pedal arm 13 to improve boost brake performance. Additionally, the hydraulic front brakes 21 may allow for a smaller booster 2 which may improve packaging and cost constraints. The hydraulic front brakes may allow for a smaller hydraulic control unit with removal of at least four valves, two pressure sensors and a pump. The rear electronic brakes 39 may provide backup braking to the vehicle 100 under some conditions.

Referring next to FIG. 3, a flow diagram 300 of an illustrative embodiment of an electro-hydraulic brake-by-wire method is shown. In block 302, a vehicle having a pair of front brakes and a pair of electronic rear brakes is provided. In some embodiments, the vehicle may be a hybrid electric vehicle (HEV). In block 304, an active vacuum booster with vacuum pump is provided. In block 306, a brake pedal is coupled to the active vacuum booster. In block 308, hydraulic circuits are coupled to the active vacuum booster. In block 310, a pair of front brakes is connected to the hydraulic circuits. In block 312, an electronic control unit (ECU) is connected to the brake pedal. In block 314, the electronic rear brakes are connected to the ECU.

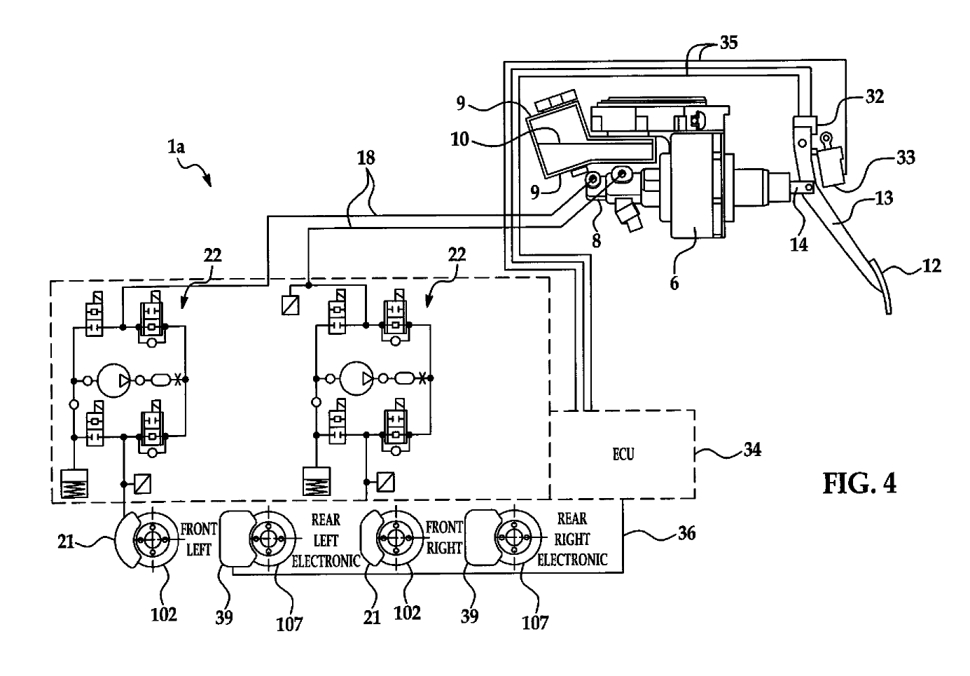

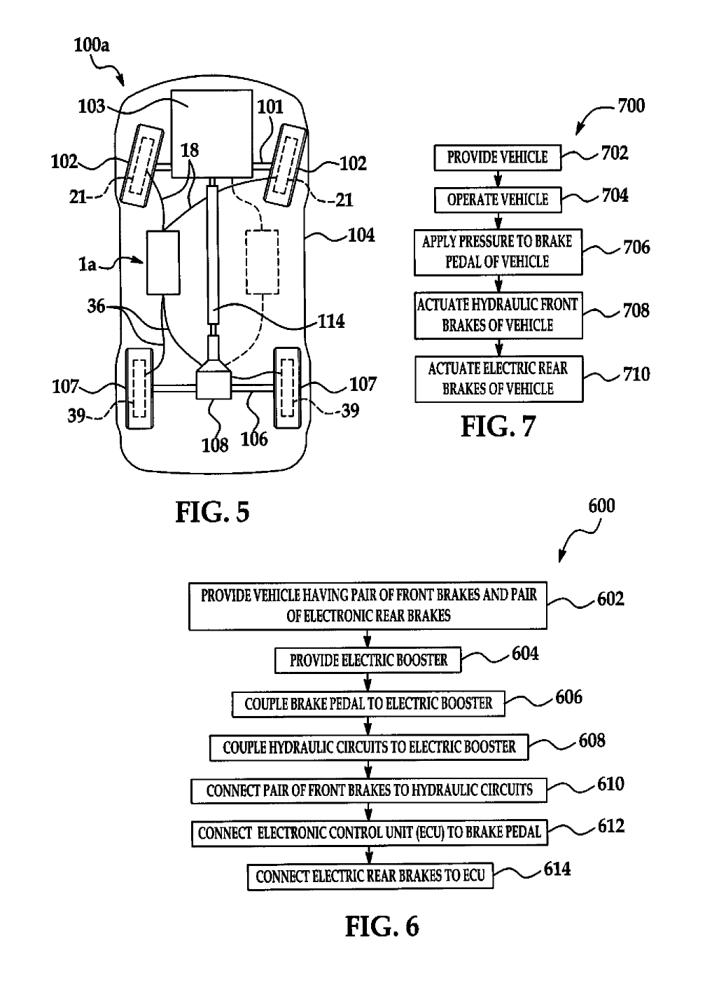

Referring next to FIGS. 4 and 5, an alternative illustrative embodiment of the electro-hydraulic brake-by-wire system, hereinafter system, is generally indicated by reference numeral 1a. As shown in FIG. 5, the system 1a may be suitable for implementation in conjunction with an electric vehicle 100a such as a plug-in hybrid electric vehicle (HEV), for example and without limitation. Generally, the electric vehicle 100a may include a vehicle chassis 104 having a front axle 101 fitted with front wheels 102, a rear axle 106 fitted with rear wheels 107, an internal combustion engine 103 and an electric motor 108 each adapted to engage at least one of the front axle 101 and the rear axle 106, as was heretofore described with respect to the vehicle 100 in FIG. 2. A rechargeable battery (not shown) may be connected to the electric motor 108. The rechargeable battery may be capable of being recharged with electrical power at a charging destination (not shown) via suitable plug-in electrical equipment, as is known to those skilled in the art. As will be hereinafter further described, the system la may be operable to apply brake pressure to the front wheels 102 and the rear wheels 107 of the vehicle 100a.

As shown in FIG. 4, the system la may include an electronic booster 6. A master cylinder 8 may be coupled to the electronic booster 6. A hydraulic fluid reservoir 9 which contains a supply of hydraulic fluid 10 may be disposed in fluid communication with the master cylinder 8. A brake pedal 12 of the vehicle 100 may be provided on an elongated pedal arm 13 which is coupled to the electronic booster 6 through a pedal/booster coupling 14.

A pair of front hydraulic brake circuits 22 may be disposed in fluid communication with the master cylinder through respective hydraulic lines 18. A pair of hydraulic front brakes 21 may be operably connected to the respective front hydraulic brake circuits 22. The hydraulic front brakes 21 may be adapted to apply hydraulically-actuated brake pressure to the respective front vehicle wheels 102 of the vehicle 100a (FIG. 5), as will be hereinafter further described.

A pedal travel sensor 32 may be coupled to the pedal arm 13. An electronic control unit (ECU) 34 may be connected to the pedal travel sensor 32 through ECU wiring 35. A pair of electronic rear brakes 39 may be connected to the ECU 34 through brake wiring 36. The electronic rear brakes 39 may be adapted to apply electronically-actuated brake pressure to the respective rear vehicle wheels 107 of the vehicle 100a (FIG. 5). The ECU 34 may additionally be connected to the valves, pumps and other various control components (not labeled) of each of the front hydraulic brake circuits 22. A pedal feel simulator 33 may additionally be provided on the pedal arm 13 and connected to the ECU 34 through ECU wiring 35.

In operation of the vehicle 100a, the internal combustion engine 103 and/or the electric motor 108 applies torque to the front wheels 102 and the rear wheels 107 to propel the vehicle 100a on a surface (not shown). Braking is applied to the vehicle 100a as a vehicle operator (not shown) applies pressure to the brake pedal 12. Accordingly, the pedal arm 13 actuates the electronic booster 6 of the system 1 through the pedal/booster coupling 14. The electronic booster 6 pressurizes and facilitates flow of hydraulic fluid 10 from the master cylinder 8 and through the hydraulic lines 18 and the respective front hydraulic brake circuits 22. The hydraulic fluid 10 which flows through the front hydraulic brake circuits 22 causes each hydraulic front brake 21 to apply brake pressure against the corresponding front wheel 102. The ECU 34 may control the valves, pumps and other components (not indicated) of each of the front hydraulic brake circuits 22 to facilitate flow of hydraulic fluid through the front hydraulic brake circuits 22 to each hydraulic front brake 21.

The pedal arm 13 also actuates the pedal travel sensor 32, which transmits an activation signal (not shown) to the ECU 34 through the ECU wiring 35. The ECU 34 transmits a braking signal (not shown) through the brake wiring 36 to each electronic rear brake 39, which applies brake pressure to each corresponding rear wheel 107. The resulting brake pressure which is applied to the front wheels 102 and the rear wheels 107 slows or stops the vehicle 100. As the brake pedal 12 is depressed during braking, the pedal feel simulator 33 may simulate mechanical resistance of the brake pedal 12 in proportion to the magnitude of braking which is applied.

It will be appreciated by those skilled in the art that the integrated rear electric brakes 39 of the system 1a offers numerous benefits including cost, package and function improvements over conventional brake arrangements, particularly with the increased use of electric park brakes. The system 1a may utilize common ABS/ESC controls which are common to conventional vacuum brake systems. The hydraulic front brakes 21 may allow for enhanced system sizing of the master cylinder 8 and pedal ratio of the pedal arm 13 to improve boost brake performance. Additionally, the hydraulic front brakes 21 may allow for a smaller booster 2 which may improve packaging and cost constraints. The hydraulic front brakes may allow for a smaller hydraulic control unit with removal of at least four valves, two pressure sensors and a pump. The rear electronic brakes 39 may provide backup braking to the vehicle 100 under some conditions.

Referring next to FIG. 6, a flow diagram 600 of an alternative illustrative embodiment of an electro-hydraulic brake-by-wire method is shown. In block 602, a vehicle having a pair of front brakes and a pair of electronic rear brakes is provided. In some embodiments, the vehicle may be a hybrid electric vehicle (HEV). In block 604, an electronic booster is provided. In block 606, a brake pedal is coupled to the electronic booster. In block 608, hydraulic circuits are coupled to the electronic booster. In block 610, a pair of front brakes is connected to the hydraulic circuits. In block 612, the ECU is connected to the brake pedal. In block 614, the electronic rear brakes are connected to the ECU.

Referring next to FIG. 7, a flow diagram 700 of an illustrative embodiment of a method of operating an electro-hydraulic brake-by-wire system is shown. In block 702, a vehicle is provided. In some applications, the vehicle may be a hybrid electric vehicle. The vehicle may have a pair of front brakes and a pair of electronic rear brakes, an active vacuum booster, a brake pedal coupled to the active vacuum booster and at least one hydraulic circuit coupled to the active vacuum booster. In some applications, a vacuum pump may be provided in fluid communication with the active vacuum booster. At least one of the pair of front brakes may be connected to the at least one hydraulic circuit. An electronic control unit may be connected to the brake pedal. At least one of the pair of electronic rear brakes may be connected to the electronic control unit. A relay may be provided between the vacuum pump and the electronic control unit. In block 704, the vehicle is operated. In block 706, pressure is applied to the brake pedal of the vehicle. In block 708, the hydraulic front brakes of the vehicle are actuated. In block 710, the electronic rear brakes of the vehicle are actuated.

Although the embodiments of this disclosure have been described with respect to certain exemplary embodiments, it is to be understood that the specific embodiments are for purposes of illustration and not limitation, as other variations will occur to those of skill in the art.

What is claimed is:

1. An electro-hydraulic brake-by-wire system for a vehicle having an active vacuum booster, comprising:
a brake pedal;
an active vacuum booster coupled to said brake pedal;
a master cylinder coupled to said active vacuum booster;
at least one hydraulic brake circuit disposed in fluid communication with said master cylinder;
at least one hydraulic front brake disposed in fluid communication with said at least one hydraulic brake circuit;
an electronic control unit connected to said brake pedal; and
at least one electronic rear brake connected to said electronic control unit.

2. The system of claim 1 further comprising a pedal arm coupled to said active vacuum booster and wherein said brake pedal is carried by said pedal arm.

3. The system of claim 2 further comprising a pedal travel sensor provided on said pedal arm and connected to said electronic control unit.

4. The system of claim 2 further comprising a pedal feel simulator provided on said pedal arm and connected to said electronic control unit.

5. The system of claim 1 further comprising a vacuum pump disposed in fluid communication with said active vacuum booster.

6. The system of claim 5 further comprising a relay between said vacuum pump and said electronic control unit.

7. The system of claim 1 wherein said at least one hydraulic brake circuit comprises a pair of front hydraulic brake circuits and said at least one hydraulic front brake comprises a pair of hydraulic front brakes connected to said pair of front hydraulic brake circuits, respectively, and said at least one electronic rear brake comprises a pair of electronic rear brakes connected to said electronic control unit.

8. A vehicle with hydraulically-actuated front braking and electronically-actuated rear braking, comprising:
a chassis;
a front axle and a rear axle carried by said chassis;
a front pair of wheels and a rear pair of wheels carried by said front axle and said rear axle, respectively;
a drive mechanism drivingly engaging at least one of said front axle and said rear axle; and
an electro-hydraulic brake-by-wire system comprising:
a brake pedal;
an active vacuum booster coupled to said brake pedal;
a master cylinder coupled to said active vacuum booster;
at least one hydraulic brake circuit disposed in fluid communication with said master cylinder;
at least one hydraulic front brake disposed in fluid communication with said at least one hydraulic brake circuit and adapted to engage at least one of said front pair of wheels;
an electronic control unit connected to said brake pedal; and
at least one electronic rear brake connected to said electronic control unit and adapted to engage at least one of said rear pair of wheels.

9. The vehicle of claim 8 wherein said drive mechanism comprises at least one electric motor drivingly engaging at least one of said front axle and said rear axle and an internal combustion engine providing power to at least one of said front axle and said rear axle.

10. The vehicle of claim 8 further comprising a pedal arm coupled to said electronic booster and wherein said brake pedal is carried by said pedal arm.

11. The system of claim 10 further comprising a pedal travel sensor provided on said pedal arm and connected to said electronic control unit.

12. The system of claim 10 further comprising a pedal feel simulator provided on said pedal arm and connected to said electronic control unit.

13. The system of claim 8 further comprising a vacuum pump disposed in fluid communication with said active vacuum booster.

14. The system of claim 13 further comprising a relay between said vacuum pump and said electronic control unit.

15. The system of claim 8 wherein said at least one hydraulic brake circuit comprises a pair of front hydraulic brake circuits and said at least one hydraulic front brake comprises a pair of hydraulic front brakes connected to said pair of front hydraulic brake circuits, respectively, and said at least one electronic rear brake comprises a pair of electronic rear brakes connected to said electronic control unit.

16. A method of operating an electronic brake actuator brake-by-wire system for a vehicle having an active vacuum booster, comprising:
providing a vehicle having a pair of front brakes and a pair of electronic rear brakes, an active vacuum booster, a brake pedal coupled to said active vacuum booster, at least one hydraulic circuit coupled to said active vacuum booster, at least one of said pair of front brakes connected to said at least one hydraulic circuit, an electronic control unit connected to said brake pedal and at least one of said pair of electronic rear brakes connected to said electronic control unit;
operating said vehicle;
applying pressure to said brake pedal;
actuating said front brakes; and
actuating said electronic rear brakes.

17. The method of claim 16 wherein said providing a vehicle comprises providing a hybrid electric vehicle.

18. The method of claim 16 wherein said providing a vehicle having at least one of said pair of front brakes connected to said at least one hydraulic circuit comprises providing a vehicle having both of said pair of front brakes connected to said at least one hydraulic circuit and wherein said providing a vehicle having at least one of said pair of electronic rear brakes connected to said electronic control unit comprises providing a vehicle having both of said pair of electronic rear brakes connected to said electronic control unit.

19. The method of claim 16 wherein said providing a vehicle comprises providing a vehicle having a vacuum pump in fluid communication with said active vacuum booster.

20. The method of claim 19 wherein said providing a vehicle comprises providing a vehicle having a relay between said vacuum pump and said electronic control unit.
